(19) United States
(12) Patent Application Publication
(10) Pub. No.: US 2011/0262882 A1
(43) Pub. Date: Oct. 27, 2011

(54) Natural Tooth Replacement (NTR): An Alternative to Tooth Root Canal (RCT) Therapy and Immediate Root-Form Implant Placement Into Extraction Socket

(76) Inventor: William Nordquist, San Diego, CA (US)

(21) Appl. No.: 13/093,688

(22) Filed: Apr. 25, 2011

Related U.S. Application Data
(60) Provisional application No. 61/343,250, filed on Apr. 26, 2010.

(51) Int. Cl. A61C 8/00

(52) U.S. Cl. 433/173

(57) ABSTRACT

The present invention relates to the method of replacing an infected, broken, decayed tooth that would otherwise require extraction or root canal therapy with a duplicate ceramic tooth implant uncoated or coated with a series of treatments and manufactured for compatibility by obtaining CAT-SCAN images of the tooth prior to extraction or by utilizing typical ‘lost wax’ duplicating technology. The invention give the dentist an alternative to performing a root canal procedure (endodontic procedure) on an infected tooth that presents the problematic and in most cases the impossible task of eliminating all the bacteria from the tooth interior and adjacent bone. The bacteriais problematic in that it causes adjacent implants to fail and thus it is presumed to cause other distal chronic inflammatory diseases if these “foci of infections” are not removed.

### CROSS-REFERENCE TO RELATED APPLICATIONS

Related U.S. Application Data: Provisional Application No. 61/343,250 filed on Apr. 26, 2010

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates to the method of replacing an infected, broken, decayed tooth that would otherwise require extraction or root canal therapy with a duplicate biocompatible ceramic tooth either manufactured entirely from or coated with a series of treatments and manufactured for compatibility by obtaining CAT SCAN images of the tooth prior to extraction or by utilizing typical ‘lost wax’ duplicating technology post-extraction.

2. Background

When a tooth decays or periodontal disease occurs to the extent that infection enters the root canal nerve chamber of a tooth and causes death and infection inside the tooth, traditional treatment includes removing the infected nerve tissue and replacing it with a root canal filling material. The efficacy of the treatment has been debated for many years. There is definite evidence that the infection causing the death of a tooth is, in spite of every attempt to remove it, ominously present in the tooth and in the vicinity of the contiguous bone. This “foci of infection” has been proven, but ignored, in the distant past to be problematic (Price W. Nutrition and Physical Degeneration, Amazon.com (8th edition, 2008).

Today, these root canal treated teeth have proved to be the source of infection that causes dental implants to fail (Nordquist W. Part III: Crystalline Fluorapatite coated hydroxylapatite: Potential Use as a bacteriostatic agent for both pre-implant cases and retreatment of infected implant sites. A report of four cases Nordquist WD and Krutchoff D. Part Crystalline fluorapatite-coated hydroxylapatite; Potential Use as a Bacteriostatic Agent for both pre-implant Cases and Retreatment of infected implant sites {A report of 4 cases 2011 JOI February; 37(1)}). If such infection is capable of causing a nearby implant to fail, there may be some relationship for failure with other infections or chronic inflammation processes occurring in the body as a result of this “foci of infection.” Infection anywhere else in the body is aggressively treated to prevent further and more dangerous infection in vital organs. Until dental implants have been proven to fail next to this problematic root canal treated teeth, any infection occurring anywhere in the body was not connected to this source of infection. Dentists have been aware of this problem of what seemed to be a subclinical infection, but they didn't correlate this to any evidence of any systemic spread.

The urgency of the seeming unseen problem was not enough to sacrifice an otherwise good tooth to prevent any infection that might spread to other tissues of the body. Another reason for this acceptance of what seemed to be an insufficient problem is that there were no good alternatives to root canal therapy short of extracting the tooth.

Weston A. Price, DDS (1870-1948) was a dentist and nutritionist. He was the chairman of the Research Section of the American Dental Association from 1914-1923, but was later marginalized by the American Dental Association for his outspoken views on what he considered the detriments of root canal therapy. He took infected teeth or extracts of them from patients suffering from a wide range of serious “medical” problems. He implanted these under the skin of laboratory animals. The laboratory animal quickly came down with the very same disease. Expected results from such an experiment would be that an infection from an implant infected tooth might go anywhere in the body of the experimental animal to cause any random disease. However, that was not the effect. What was observed was that if the donor patient had infected kidneys and his infected tooth was implanted in several lab animals, essentially all the animals quickly developed infected kidneys (W. Price, supra). Price claimed to have found that 95% of focal infections started in the teeth and tonsils.

Price theorized that harmless bacteria normally found in the mouth gets trapped in the dentinal tubules of infected teeth and somehow mutate into a more dangerous form. The new mutated bacteria and/or the toxic poisons they create travel through the blood stream and lymphatic system to remote body parts and cause disease. Price went on to demonstrate that even when root canal treatment is done according to accepted modern principles and even the follow-up x-rays show good, this didn't solve the spread of infection problem.

In the 1960 classic studies of Brynolf, cadavers were used to study root canal-treated teeth. (Brynolf I. A histological and roentgenological study of the periapical region of upper incisors. Odont Revy. 1967; (11):1-97.) These teeth were X-rayed and evaluated for evidence of radiolucent lesions at the apex or tip of the root deepest in the bone. The teeth were then cut from the bone with saws in block sections. The sections were treated and prepared for microscopic examination. Brynolf's evidence as a result of these examinations revealed that a lack of infection at the base of a root canal-treated tooth did not preclude inflammation or inflection at the apex of the tooth. She concluded that 93 percent of root canal-treated teeth examined in cadavers had microscopic signs of inflammation (infection), presumably caused by bacteria in the area.

Dr. Green studied more cadavers in 1997 and characterized Brynolf's studies as questionable because of differences both in treatment techniques and methods of radiographic and histological analysis that were being used at the time. Green reported that out of the 29 teeth examined, 15 had an alarming 52 percent histological evidence of inflammation, presumably infection associated with bacteria.

William Nordquist, (2009), published a book concerning oral spirochetosis and systemic disease (Nordquist W. The Stealth Killer: Is oral spirochetosis the missing link in the dental-heart disease labyrinth? BioMed Publishing Group, 2009; Nordquist W. Oral spirochetosis associated with dental implants: Important clues to systemic disease. Int'n J of Clin Impl Dent; 1(1); January-April; 2009). In chapter 6, Nordquist discusses the role of infected teeth, including root canal treated teeth, and how they play in the systemic chronic inflammatory disease labyrinth. He demonstrates that undiagnosed infected teeth nearby a dental implant can cause the implant to fail.

Reports of dental implant failures, along with the large percentage of periapical lesions associated with root canal teeth in cadavers, present problematic evidence for the practice of medicine. The risks to dentistry as a result of this ignorance as a whole are unimaginable, due to the liability that may now be attributed to dental clinicians because of recent findings relating dental infection to heart and other systemic diseases.

Natural Tooth Replacement (NTR) is a method for replacing decayed, abscessed teeth in lieu of performing root canal therapy. Once a tooth is deemed necrotic or dead, it is carefully extracted and a replacement tooth is manufactured that simulates the structure and esthetics of the tooth exactly. Once the natural tooth is duplicated in durable biocompatible ceramic the surface chemistry is modified by blasting and/or etching for maximum biocompatibility and/or coated with combinations of biocompatible ceramic/ceramics and then placed into the extraction socket.

3. Description of Related Art

CAT/SCAN combines special x-ray equipment with sophisticated computers to produce multiple images or pictures of the inside of the body. These cross-sectional images of the area being studied can then be examined on a computer monitor, printed or transferred to a CD. Cone Beam imaging is proving to be a popular choice for dentists seeking accurate and detailed scans used in many oral surgery and implant dentistry procedures. Current three dimensional cone beam devices include ICat, Planmeca and Galileos.

Dental implants are constructed from a range of materials such as titanium, stainless steel, titanium alloy and zirconium oxide ceramics. Ceramic tooth implants, specifically known as zirconium or zirconia dental implants, are one of the newer forms of dental implants, tooth-colored, compatible with our tissues, and made of the hardest material next to diamonds.

Since the middle of the 1980s, zirconium oxide has a firm place among high performance ceramics and has already been used for more than 20 years for hip joint replacement implants. Dental ceramic implants are bio-compatible (completely tissue-friendly); there are no allergic reactions, no sensitivity to temperature and no impact on taste. The zirconium oxide ceramic shows no interactions with other dental materials and is electrically neutral. Because of a friendly gum reaction and due to dental plaque being less attached to them, the crown margin shows no symptoms of inflammation in the gums region. Better gum health minimizes the risk of losing an implant.

Since zirconium is white and is much more similar to natural teeth, the aesthetics is more easily achieved than regular titanium implants. Even if soft tissue around the tooth recede, which is possible over time, ceramic dental implants will not reveal ugly gray lines like in the case of titanium implants.

Commercial zirconia implant systems currently available are the following: (1) CeraRoot (Oral Iceberg, Barcelona, Spain); (2) Sigma (Incermed, Lausanne, Switzerland); (3) White Sky (Bredent Medical, Senden, Germany); (4) Z-systems (Z-systems, Konstanz, Germany); (5) Zit-z (Ziterion, Uffenheim, Germany)

The current method of implant replacement of a missing tooth involves drilling circular hole in the alveolar bone, threading in the implant, attaching a screw to the implant body ensuring the cove screw is out of occlusion with the opposing teeth so as to promote bone growth over the course of several months, then replacing the cover screw, placing an abutment on the implant and finally restoring the abutment with a crown.

The lost wax casting process is widely used as it offers asymmetrical casting with very fine details to be manufactured relatively inexpensively. The process involves producing a metal casting using a refractory mold made from a wax replica pattern. From the impression, a model is made. The most common model is made out of a gypsum product, but synthetic gypsum, epoxy, and resins are gaining in use. Whichever material is used, will produce an accurate working model of the patient's teeth.

A recent development in the area of single implantation is found in U.S. patent application Ser. No. 11/832,213 filed Aug. 1, 2007, by inventor K. Tim Mount of Okmulgee, Okla. This method does not use a screw as is prevalent in the industry, but instead a is a method of milling a computer modeled titanium implant that contains chevron retention fins in a random pattern in the root portion of the implant. The chevrons act somewhat like a screw on conventional implants but do not create spiral threads requiring turning upon placing the implant. The chevrons, being one directional, do not allow the tooth to come out after implant.

After implantation, a temporary crown is cemented on the implant by traditional methods and replaced after several months.

The present invention is a departure from and improvement to both the traditional ‘screw’ method that oftentimes utilizes ceramic implants and the recently proposed ‘chevron’ method utilizing titanium implants. It provides for a ceramic tooth implant manufactured using either CAT-SCAN technology or ‘lost wax’ duplicating technology. The implant's root surfaces are manufactured from a ceramic and modified by blasting and/or etching to increase surface roughness for maximum biocompatibility. The root can be further treated by coating with an additional biocompatible ceramic, i.e., with a fluorapatite ceramic for increasing biocompatibility with the root surface and further blasted, etched and electronically activated to achieve maximal implantation integrity. The implant requires neither spiral threads nor chevrons. Since there is more implant-to-bone surface the implant would achieve more stability than traditional root-form implants. Further, the implant would significantly reduce the failure of adjacent teeth caused by infections from the prior extracted necrotic root canal treated (RCT) tooth.

### BRIEF SUMMARY OF THE INVENTION

The present invention is an improvement to dental implant and method for making and installing the implant into a patient's mouth. The invention calls for the immediate ceramic implant replacement of an extracted tooth or for implanting into root areas having already missing teeth. The method employs CAT-SCAN or ‘lost wax’ methods to manufacture a ceramic implant replacement. The ceramic root surface of the replacement would further be manufactured from or treated with a series of treatments to activate the surface to maximize biocompatibility.

Briefly, the steps involved in practicing the invention would be (1) CAT-SCAN of tooth before extraction, or extract, scan with electronic duplicating technology to mill the final ceramic tooth, or make a mold; (2) generate a duplicate tooth out of ceramic; (3) fire, crystallize, or sinter the ceramic duplicate to achieve proper structural integrity; (4) the root surface either treated by blasting and/or acid etching and/or is layered with apatite ceramic and firing; and (5) the root surface is further treated with a series of treatments to activate the surface to maximize biocompatibility. The root surface alternative treatments include: (1) fluorapatite, (2) hydroxylapatite, (3) roughen zirconium surface, (4) roughen lithium disilicate surface, or any other novel ceramic surface.

### BRIEF DESCRIPTION OF THE SEVERAL VIEWS OF THE DRAWINGS

FIG. 1 is a perspective view of a lower tooth prior to extraction from the patient's mouth while a CAT SCAN unit is used to obtain a three dimensional image of the tooth for manufacture of the replacement implant.

FIG. 2 is a perspective view of the lower tooth extraction socket after the natural tooth was extracted.

FIG. 3 is a view of the extracted natural tooth with proposed tooth preparation.

FIG. 4 is a view of the natural tooth after preparation for duplication.

FIG. 5 is a view of the ceramic tooth duplication of the natural tooth after utilizing the ‘lost wax’ process; it can also be duplicated by electronic scanning and milling after the tooth has been extracted or using CAT SCAN duplication technology employed prior to extraction. At this point the surface of the ceramic tooth can be modified by blasting and/or etching to maximize biocompatibility and the ceramic tooth can be placed in to the socket as is.

FIG. 6 is a perspective view of the manufactured ceramic tooth with flourapatite coating 1.

FIG. 7 is a perspective view of the ceramic duplicate tooth placed into the extraction socket with the flourapatite coating 1.

FIG. 8 is a perspective view of the ceramic tooth placed into the extraction socket with a finished crown and flourapatite coating 1.

### DETAILED DESCRIPTION OF THE INVENTION

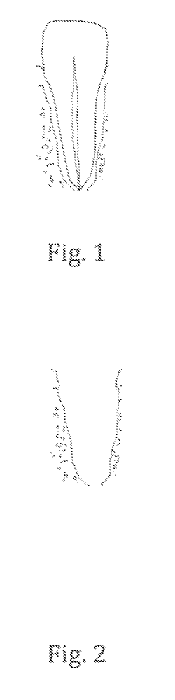

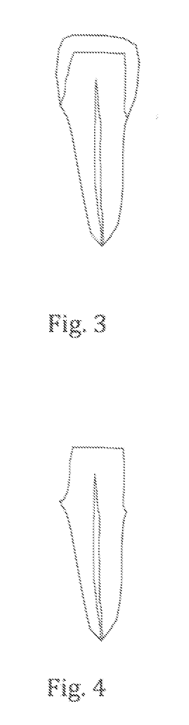

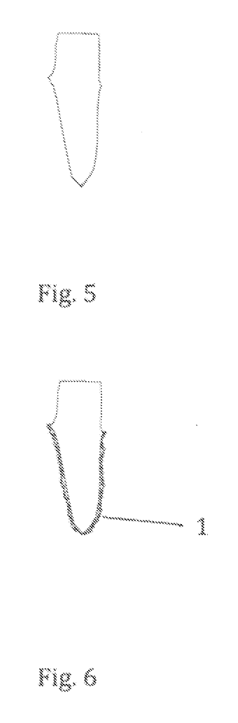

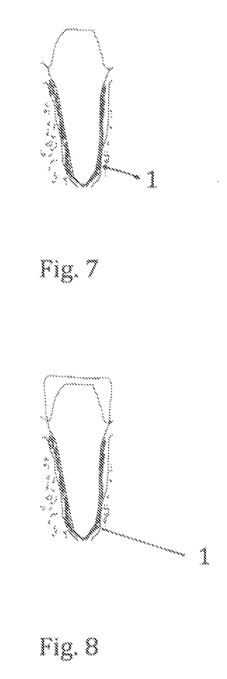

The present invention is an improvement on current and proposed methods for the manufacture and insertion of dental implants by replacing an infected, broken, decayed tooth (FIG. 1) that would otherwise require extraction or root canal therapy with a duplicate ceramic tooth implant (FIG. 5 or 6) treated and/or coated with a series of treatments and that was manufactured for compatibility by utilizing either CAT-SCAN technology or a typical ‘lost wax’ duplicating process for modeling an implant after the natural tooth (FIG. 3). The tooth is extracted using gentle methods to preserve the bony socket (FIG. 2). The tooth can be duplicated entirety with the crown portion or can be prepared similarly as for a crown preparation (FIG. 4). Once prepared, or when used as the entire unprepared tooth, it is duplicated using either a CAT-SCAN technology prior to extraction, electronically scanned and milled after extraction, or “lost-wax” methods into an exact ceramic duplicate (FIG. 5). The root surface is then treated with a series of biocompatibility surfaces 1 by blasting and/or etching treatment to either roughen, and/or coat the surface with biocompatible ceramic, i.e., fluorapatite, for maximum root surface biocompatibility for osseous integration (FIG. 6). The duplicated tooth is then surgically installed into the extraction socket and stabilized with whatever methods are required to prevent any movement during the first six weeks of re-implantation (FIG. 7). After a period of time and when bio-integration is completed as determined by the clinician, a crown preparation is refined and an impression is taken for the final restorative esthetic crown (FIG. 8). This method establishes perfect emergence profile for maximum esthetic and stability for long-term serviceability.

1. A method of replacing an extracted natural tooth with a dental implant comprising a biocompatible ceramic such as lithium disilicate, zirconium, apatite, or any other bio-compatible ceramic duplicate of the original natural tooth that required extraction for any reason.

2. A method of replacing an extracted natural tooth with a dental implant comprised of coating the surface of a duplicate tooth root replacement with a bio-compatible ceramic material, i.e. fluorapatite, hydroxylapatite, or any other biocompatible ceramic.
